(19) United States
(12) Patent Application Publication
(10) Pub. No.: US 2026/0274374 A1
(43) Pub. Date: Sep. 17, 2026

(54) BICYCLE TRANSMISSION

(71) Applicant: RatioX Sàrl, Lausanne (CH)

(72) Inventors: Simon FANECO, Lausanne (CH); Sandro MARES, Embrach (CH)

(73) Assignee: RatioX Sàrl, Lausanne (CH)

(21) Appl. No.: 19/415,207

(22) PCT Filed: Jun. 15, 2023
(86) PCT No.: PCT/EP2023/066160

§ 371 Date: Dec. 10, 2025

(51) Int. Cl. B62M 11/14; B62J 45/41; B62J 45/421; B62M 9/08

(52) U.S. Cl. CPC B62M 11/145; B62J 45/41; B62J 45/421; B62M 9/08

(57) ABSTRACT

The present invention relates to a bicycle gearbox (1000) comprising a housing (1100), which comprises two crankshaft openings (1110), configured to allow a crankshaft 1600 to pass through it. The gearbox further comprises a continuously variable transmission (1300) with an input pulley (1310), an output pulley (1330) and a V-belt (1320) connecting them, a chain sprocket (1500), configured to connect to a chain connecting to the rear wheel, and input gears as well as output gears. The input gears (1200) are configured to connect the crankshaft (1600) to the input pulley (1310) while increasing a rotational speed of the crankshaft (1600) and provide the increased rotational speed to the input pulley (1310). The output gears (1400) are configured to connect the output pulley (1330) to the chain sprocket (1500), while reducing a rotational speed of the output pulley (1330) and provide the reduced rotational speed to the chain sprocket (1500). In the invention, the output pulley (1330) is coaxial with the crankshaft (1600).

### RELATED APPLICATION DATA

This application is a national stage entry of International Application No. PCT/EP2023/066160, filed Jun. 15, 2023, the disclosure of which is incorporated herein by reference.

### FIELD OF THE INVENTION

The present invention relates to a gearbox layout that is compact, light and able to provide a functional continuously variable transmission for a bicycle, also allowing integration into a bicycle frame.

### BACKGROUND OF THE INVENTION

Gearboxes based on continuously variable transmissions for bicycles are known, for instance from document WO2017103110A1, which are based on two pulleys and a V-belt.

Those known designs face several difficulties.

The pulleys and the V-belt of the continuously variable transmission are sized so that they can transmit a limited torque, for instance in the order of magnitude of 10 Nm, compared to the input torque, for instance in the order of magnitude of 200 Nm. This results in the need of gears before the continuously variable transmissions, to increase the rotational speed of the continuously variable transmissions compared to the crankshaft. This, in turn, makes the rotational speed of the continuously variable transmissions too high for direct transmission to the wheels, so that further gears are needed to reduce the rotational speed of the continuously variable transmissions before transmission to the wheel.

Those gears contribute to the width of the gearbox, so that it is important to have an arrangement of the components which makes the gearbox compact.

Additionally, bicycle transmissions require the use of a freewheel. Common freewheels for bicycles are rather heavy, as they transmit high torque at low speed.

Still further, it has been found that if the housing of the gearbox is made of a thin and light material, such as aluminum, in order to reduce weight, the sidewalls of the gearbox can flex under heavy load. This renders the gearbox noisy and reduces lifetime, since the bearings, mounted in the sidewalls, no longer align properly with the respective axles.

Additionally, when the gearbox is used in conjunction with electric bicycles, there are ways to make the gearbox better adapted to issues specific to electric bicycles.

In particular, electric bicycles are known to comprise torque sensors, to provide an input to the controller powering the electric motor. Current torque sensors are often complex axial electro-magnetic torque sensors in the bottom bracket. Additionally, if the crank output is provided to a right-hand chainwheel, then the force from a righthand pedal goes directly to the back wheel and does not pass through the torque sensor. Therefore, complex algorithms are required to predict what the right foot will do based on the measurement from the left foot. This leads to issues when, for instance, a rider starts moving by only pressing the right pedal. In this case the sensor does not receive a load, and therefore the motor does not provide any power assistance. Similarly, when stopping, if a rider has pressed the left pedal, and then stops pedaling, or even brakes, the motor will continue to apply power for some time. These issues impact usability of the electric bicycles.

### SUMMARY OF THE INVENTION

In accordance with an aspect of the invention, a bicycle gearbox includes a housing, the housing comprising two crankshaft openings, configured to allow a crankshaft to pass through the housing. The bicycle gearbox further comprising a continuously variable transmission comprising an input pulley, an output pulley and a V-belt connecting the input pulley and the output pulley, and a chain sprocket, configured to connect to a chain connecting to the rear wheel. The bicycle gearbox further comprising input gears configured to connect the crankshaft to the input pulley, the input gears being configured to increase a rotational speed of the crankshaft and provide the increased rotational speed to the input pulley. The bicycle gearbox further comprising output gears configured to connect the output pulley to the chain sprocket, the output gears being configured to reduce a rotational speed of the output pulley and provide the reduced rotational speed to the chain sprocket. The embodiment being characterized in that the output pulley is coaxial with the crankshaft.

In some embodiments, the input gears can be configured to increase the rotational speed of the input pulley with respect to the rotational speed of the crankshaft by an increasing factor, wherein the increasing factor can be at least 10, preferably at least 20, even more preferably at least 25, and/or wherein the increasing factor can be less than 50, preferably less than 40, even more preferably less than 35.

In some embodiments, the output gears can be configured to reduce the rotational speed of the output pulley by a reducing factor, wherein the reducing factor can be at least 0.01, preferably at least 0.05, even more preferably at least 0.1, and/or wherein the reducing factor can be less than 0.3, preferably less than 0.2, even more preferably less than 0.15.

In some embodiments, the continuously variable transmission can be configured to have a gear range between 1.5 and 10.0, preferably between 1.8 and 4.0.

In some embodiments, the input gears and the continuously variable transmission can be configured so that the input pulley, when the gearbox is in use, can have an input rotational speed wherein the input rotational speed can be at least 500 RPM, preferably at least 1000 RPM, even more preferably at least 1500 RPM, and/or wherein the input rotational speed can be less than 3500 RPM, preferably less than 3000 RPM, even more preferably less than 2500 RPM.

In some embodiments, the output gears and the continuously variable transmission can be configured so that the output pulley, when the gearbox is in use, can have an output rotational speed wherein the output rotational speed can be at least 500 RPM, preferably at least 700 RPM, and/or wherein the output rotational speed can be less than 4500 RPM, preferably less than 4000 RPM. and/or wherein the output rotational speed can have a range of at least 1000 RPM, preferably at least 2000 RPM, even more preferably at least 2500 RPM.

In some embodiments, the housing can have its longest dimension along a main elongation axis and can be configured to be connected to a frame tube of a bicycle, wherein the frame tube can be any of a seat tube, a down tube and chain stays, or other non-standard frame construction and wherein the housing can be configured to be connected to the frame tube such that the frame tube can be positioned parallel to the main elongation axis.

In some embodiments, the output gears can be an epicyclic gear system, comprising a sun gear, a plurality of planet gears, and a ring gear, and the sun gear can be coaxial with the crankshaft.

In some embodiments, the chain sprocket can be coaxial with the crankshaft.

In some embodiments, the input gears can be a parallel spur gear system.

In some embodiments, the input gears can comprise a first input gear, a second input gear actuated by the first input gear, a third input gear connected to the second input gear, and a fourth input gear actuated by the third input gear, the second input gear and the third input gear can be mounted on an axle, a longitudinal axis of the axle can be positioned in a region between the input pulley and the output pulley.

In some embodiments, the bicycle gearbox, can further comprise a freewheel, wherein the input pulley can be configured to rotate with an input pulley axis, and wherein the freewheel can be connected between the input pulley axis and the input pulley.

In some embodiments, the input pulley can comprise a fixed sheave and a sliding sheave, wherein the freewheel can be connected between the input pulley axis and the fixed sheave.

In some embodiments, the freewheel can be substantially coplanar with the fixed sheave.

In some embodiments, the housing can be split along a first split line into a bottom housing portion and a top housing portion, and the bottom housing portion and the top housing portion can be connected to each other in a separable manner.

In some embodiments, the top housing portion can be configured for being solidly connected to a seat tube and to a down tube of a bicycle frame, or any other non-standard bicycle frame configuration.

In some embodiments, the top housing portion can be configured for being further solidly connected to chain stays of the bicycle frame.

In some embodiments, the crankshaft openings can be realized in the bottom housing portion.

In some embodiments, the input pulley can be configured to rotate on an input pulley axis, the output pulley can be configured to rotate on an output pulley axis, an extension of the input pulley axis and an extension of the output pulley axis can both cross a side surface of the bottom housing portion.

In some embodiments, the housing can further comprise a plurality of ribs with a corresponding plurality of holes, the housing can further comprise two side surfaces substantially perpendicular the crankshaft, wherein at least a first one of the ribs can be integrated in a respective one of the side surfaces, preferably the first one of the ribs can be substantially perpendicular to the first split line.

In some embodiments, the input pulley can be configured to rotate around an input pulley axis, the output pulley can be configured to rotate around an output pulley axis, the first one of the ribs can be positioned between the input pulley axis and the output pulley axis.

In some embodiments, at least one of the bottom housing portion and the top housing portion comprises a flange along the first split line.

In some embodiments, the bottom housing portion can be split along a second split line into a first bottom housing portion and a second bottom housing portion.

In some embodiments, the output pulley can comprise a sliding sheave and a fixed sheave, the gearbox can further comprise a centrifugal actuator configured to control the output pulley as a function of the rotational speed of the output pulley, the centrifugal actuator comprising a case, a plate, a plurality of weights placed between the case and the plate, such that the weights can be configured to push the case away from the plate as the output pulley rotates, a spring configured to bias the sliding sheave towards the fixed sheave to clamp the belt, and wherein the plate can be configured so that a free volume can be present radially between the plate and the output pulley axis such that the spring can be positioned in the free volume.

In some embodiments, the bicycle gearbox, can further comprise a force sensor locating inside the housing, the force sensor comprising a first connecting portion connected to the housing, a holding portion configured to hold one axle of any of the continuously variable transmission, input gears, and output gears, a first strain gauge configured to measure a strain between the first connecting portion and the holding portion.

In some embodiments, the force sensor can further comprise a second connecting portion connected to the housing and a second strain gauge configured to measure a strain between the second connecting portion and the holding portion.

In some embodiments, the holding portion can be configured to hold an axle of the input gears rotating faster than the crankshaft.

According to another aspect of the invention, a bicycle frame includes a seat tube, a down tube and chain stays, and the bicycle gearbox of any of the previous embodiments, wherein the bicycle gearbox can be solidly connected to at least the seat tube and to the down tube.

In some embodiments, the top housing portion can be solidly connected to at least the seat tube and to the down tube, the bottom housing portion can be not solidly connected to the bicycle frame.

According to another aspect of the invention a bicycle includes the bicycle gearbox according to any of the previous embodiments, or the bicycle frame according to any of the previous embodiments.

### BRIEF DESCRIPTION OF THE DRAWINGS

FIG. 1A schematically illustrates a bicycle frame BF comprising a bicycle gearbox 1000;

FIG. 1B schematically illustrates a top schematic view of a bicycle gearbox 1000, with a top housing portion removed;

FIG. 2 schematically illustrates a partial top view of a bicycle gearbox 2000, with a top housing portion removed, comprising a possible embodiment of input gears 2200;

FIG. 3 schematically illustrates a partial top view of a bicycle gearbox 3000, with a top housing portion removed and with a cut view of a pulley sheave 3312, taken along line B-B′ of FIG. 1A, comprising a possible embodiment of freewheel 3700;

FIG. 4A schematically illustrates an enlarged view of bicycle gearbox 4000 in a closed state;

FIG. 4B schematically illustrates an enlarged view of bicycle gearbox 4000 in an open state;

FIG. 4C schematically illustrates an enlarged view of bicycle gearbox 4000 in a closed state comprising a possible embodiment of rib 4154;

FIG. 4D schematically illustrates a top view of bicycle gearbox 4000 in an open state and with a top housing portion removed;

FIG. 4E schematically illustrates a section of housing 4100, in an open position, taken along line E-E′ of FIG. 4D;

FIG. 4F schematically illustrates a section of a possible implementation of bottom housing 4120;

FIG. 5 schematically illustrates a cut view of a possible embodiment of centrifugal actuator 5340;

FIG. 6A schematically illustrates a force sensor 6800, FIG. 6B schematically illustrates a possible mounting location of force sensor 6800 inside of a bicycle gearbox 6000.

### DETAILED DESCRIPTION OF THE INVENTION

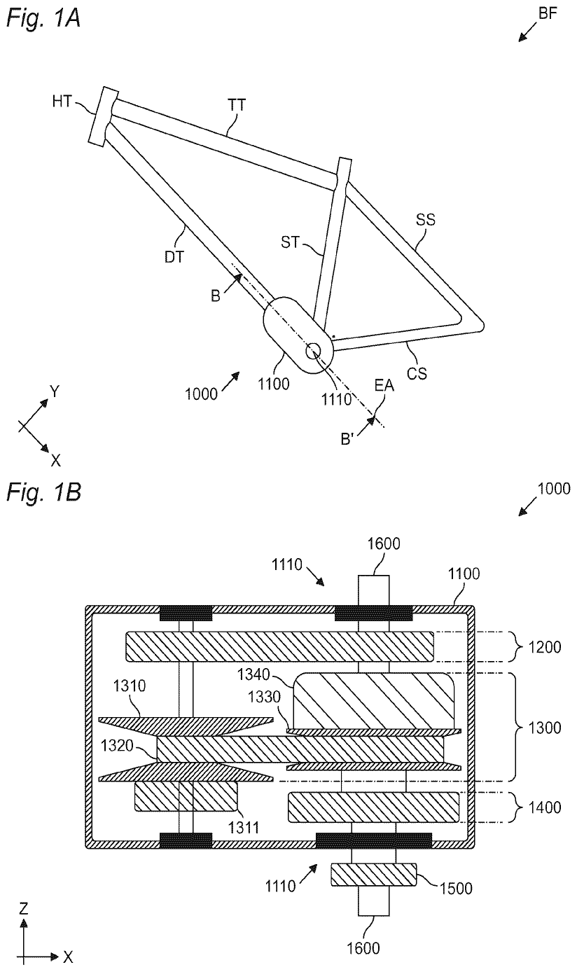

FIG. 1A schematically illustrates a bicycle frame BF comprising a bicycle gearbox 1000. A top schematic view of the gearbox 1000, with a top housing portion removed, is shown in FIG. 1B.

As can be seen, the bicycle gearbox 1000 has a housing 1100 which has a substantially elongated shape, along a main elongation axis EA. That is, the housing 1100 has its longest dimension along a main elongation axis EA of the housing 1100. It will be clear that the main elongation axis EA can be placed in any direction with respect to the bicycle frame BF. The housing 1100 is made of generally resilient material, preferably of metal and even more preferably of aluminum, and is configured to be connected to a frame tube of a bicycle, which can be any of a seat tube ST, a down tube DT and chain stays CS, or other non-standard frame construction.

The connection between the housing 1100 and the frame can be of any known type, preferably however the housing 1100 is welded to one or more, preferably two or more, even more preferably three of the frame's tubes.

Preferably, as it is the case for the down tube DT in FIG. 1, the housing 1100 is configured to be connected to a given frame tube such that the frame tube is positioned parallel to the main elongation axis EA. This is particularly advantageous, since it allows the housing 1100 to be used as a structural element, replacing at least part of the respective frame tube. In this manner, the housing replaces some otherwise present material, thus reducing weight of the bicycle.

As visible in FIG. 1A, the housing 1100 comprises two crankshaft openings 1110, of which only the left one is visible but it will be understood that the right one is symmetrically placed, configured to allow a crankshaft 1600 to pass through the housing 1100.

The gearbox 1000 further comprises a continuously variable transmission 1300, itself comprising an input pulley 1310, an output pulley 1330 and a V-belt 1320 connecting the input pulley 1310 and the output pulley 1330.

A chain sprocket 1500, visible in FIG. 1B and not illustrated in FIG. 1A for clarity of illustration, is configured to connect to a chain connecting to the rear wheel, in a manner per se known.

Generally the operation of the gearbox 1000 is that power is transmitted from the crankshaft 1600 to the input pulley 1310, trough input gears 1200 which will be described later, from the input pulley 1310 to the output pulley 1330 through the V-belt 1320, and from the output pulley 1330 to the chain sprocket 1500 through output gears 1400, which will also be described later. This enables the continuously variable transmission 1300 to operate at a rotational speed which is different from the rotational speed of the crankshaft 1600 and/or of the chain sprocket 1500. This is particularly advantageous since it has been found by the inventor that, specifically for bicycle application, the continuously variable transmission 1300 operates better at rotational speeds which are higher than those normally applied to the crankshaft 1600 and/or of the chain sprocket 1500.

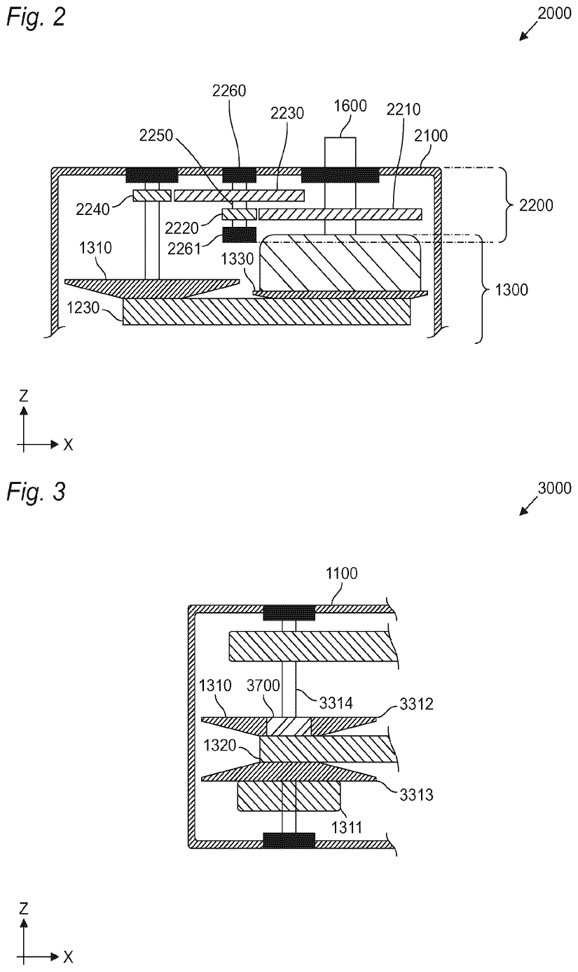

As indicated, the gearbox 1000 comprises input gears 1200, which are generally configured to connect the crankshaft 1600 to the input pulley 1310. In particular, the input gears 1200 are configured to increase a rotational speed of the crankshaft 1600 and provide the increased rotational speed to the input pulley 1310. The input gears 1200 are only schematically illustrated in FIG. 1B it will however be clear to those skilled in the art that they can be implemented in any known manners, for instance by planetary gears, by cog wheels, etc. A more specific example of a possible implementation will be discussed later with reference to FIG. 2.

The output gears 1400 are similarly generally configured to connect the output pulley 1330 to the chain sprocket 1500, and more in particular so as to reduce a rotational speed of the output pulley 1330 and provide the reduced rotational speed to the chain sprocket 1500. The same considerations made for the specific implementation of the input gears 1200 also applies to the output gears 1400. In preferred embodiments, the output gears 1400 is implemented as a planetary gearset, with the axle of the sun gear being in line with the axle of the crankshaft 1600.

Preferably, the input gears 1200 and the output gears 1300 are placed on two opposite sides of the continuously variable transmission 1300. This has been found to allow for an efficient configuration of the gearbox 1000.

As illustrated in FIG. 1B, the output pulley 1330 are coaxial with the crankshaft 1600. It will be clear to those skilled in the art that this can be implemented in several manners. For instance, the pulley 1330 can be mounted on bearings mounted on the crankshaft 1600. Alternatively, or in addition, the crankshaft 1600 can be inserted in one or more cylindrical sleeve, coaxial with the crankshaft 1600, and the pulley 1330 can be mounted on bearings mounted on the one or more sleeve.

This construction, which differs from the known prior art, is particularly advantageous because it enables a granter gear range for the input gears 1200 and/or for the output gears 1400, compared to the prior art. Moreover, this configuration is more compact in the width, along the Z direction, of the pedal crank, which is a key factor for many bikes to reduce the Q factor, or the width of the pedals. In particular, a narrower Q factor is better for rider efficiency and reduced impact on the legs.

More specifically in preferred implementations in which the input gears 1200 as implemented as a two-stage spur gear arrangement, a higher gear range can be ob-tained than with a single planetary gearbox, and with a thinner dimension. While a dual stage planetary gearbox could be used as well, for the input gears 1200, this would likely result in a wider implementation. As it will be clear to those skilled in the art, a two-stage spur arrangement can be implemented by two pairs of cogwheels, where the output of one pair drives the input of the other pair.

In preferred embodiment, the implementation described above allows the input gears 1200, 2200 to increase the rotational speed of the input pulley 1310 with respect to the speed of the crankshaft 1600 by an increasing factor, which is at least 10, preferably at least 20, even more preferably at least 25. The inventors have found that this amount of increase leads the continuously variable transmission 1300 to operate in a range which, for average crankshaft speeds, leads to an ideal size and function of the continuously variable transmission 1300. While the above limitation applies to a mini-mum value of the increasing factor, in some embodiments the increasing factor can also be limited in its upper value. Thus, in some optional embodiments, the increasing factor can be less than 50, preferably less than 40, even more preferably less than 35.

Similarly, in preferred embodiments the output gears 1400 are configured to reduce the rotational speed of the output pulley 1330 by a reducing factor, which can be at least 0.01, preferably at least 0.05, even more preferably at least 0.1. In some optional embodiments the reducing factor can be less than 0.3, preferably less than 0.2, even more preferably less than 0.15.

It will be understood by those skilled in the art that the increasing factor can be defined as

$$increasing factor = \frac{rotational speed of input pulley 1310}{rotational speed of crankshaft 1600}$$

and the reducing factor can be defined as

$$reducing factor = \frac{chain sprocket 1500}{rotational speed of output pulley 1330}$$

Moreover, it has been found by the inventors through extensive tests and ex-perimentation, that a gear range between 1.5 and 10, preferably between 1.8 and 4 is ideal for the continuously variable transmission 1300. In other embodiments, it has been found by the inventors that a gear range is preferably higher than 1.5, even more preferably higher than 1.8 and/or preferably lower than 10, even more preferably lower than 4. The gear range can be defined as

$$\frac{rotational speed output pulley in high gear}{rotational speed output pulley in low gear}$$

Similarly, the inventors have found that it is particularly advantageous to config-ure the input gears 1200 and the continuously variable transmission 1300 so that the input pulley 1310, when the gearbox 1000 is in use, has an input rotational speed of at least 500 RPM, preferably at least 1000 RPM, even more preferably at least 1500 RPM, and/or less than 3500 RPM, preferably less than 3000 RPM, even more preferably less than 2500 RPM.

Similarly, the inventors have found that it is particularly advantageous to config-ure the output gears 1400 and the continuously variable transmission 1300 so that the output pulley 1330, when the gearbox 1000 is in use, has an output rotational speed of at least 500 RPM, preferably at least 700 RPM, and/or less than 4500 RPM, preferably less than 4000 RPM. Alternatively, or addition, it has been found particularly advantageous for the output rotational speed to have a range of at least 1000 RPM, preferably at least 2000 RPM, even more preferably at least 2500 RPM.

All the numerical values above are not intended to limit the invention. However, they have been found as being a particularly effective configuration which results in a smaller size for the gearbox 1000 and yet in an effective operation of it.

As previously described in preferred embodiments and as visible for instance in FIG. 1B, the output gears 1400 can be implemented by an epicyclic gear system, or a planetary gear, comprising a sun gear and a plurality of planet gears and a ring gear. Preferably, the sun gear can be coaxial with the crankshaft 1600. For the mounting of the epicyclic gear system on the crankshaft 1600 without the epicyclic gear system rotating together with the crankshaft 1600, the same considerations made above for the output pulley 1330 apply. In particular, the epicyclic gear system can be separated from the crankshaft 1600 by one or more bearings and/or sleeves, as appropriate. The input of the output gears 1400 can be the output pulley 1330.

In further preferred embodiments, the chain sprocket 1500 can be coaxial with the crankshaft 1600. Similarly, also the output of the output gears 1400 can be coaxial with the crankshaft 1600, and can be connected to the chain sprocket 1500. The same considerations made above for the coaxial mounting on the crankshaft also applies to the output of the output gears 1400 and/or to the chain sprocket 1500.

This has been found to be particularly advantageous because it allows a coaxial output from the output pulley 1330, which can itself be coaxial with the crankshaft, so that a chain or belt can be located on the same axis as on a typical bike which renders the gearbox 1000 compatible with existing bicycle frame layouts.

As described above, in preferred embodiment, the input gears can be implemented with a non-planetary gearset, and preferably with a two-stage spur mecha-nism. An example of one such possible implementation is illustrated in FIG. 2. In particular, FIG. 2 schematically illustrates a partial top view of a bicycle gearbox 2000, with a top housing portion removed.

As can be seen in FIG. 2, the input gears 2200 are a parallel spur gear system. That is, they comprise a plurality of cogwheels, or gears, which are placed parallel to each other. Preferably, the input gears 2200 comprise a first input gear 2210, a second input gear 2220 actuated by the first input gear 2210, a third input gear 2230 connected to the second input gear 2220, and a fourth input gear 2240 actuated by the third input gear 2230. As already indicated, this configuration is particularly advantageous in that it enables input gears 1200 to be thinner than otherwise possible with a comparable planetary gear, resulting in overall lower size and weight for the gearbox 1000 and a better Q factor.

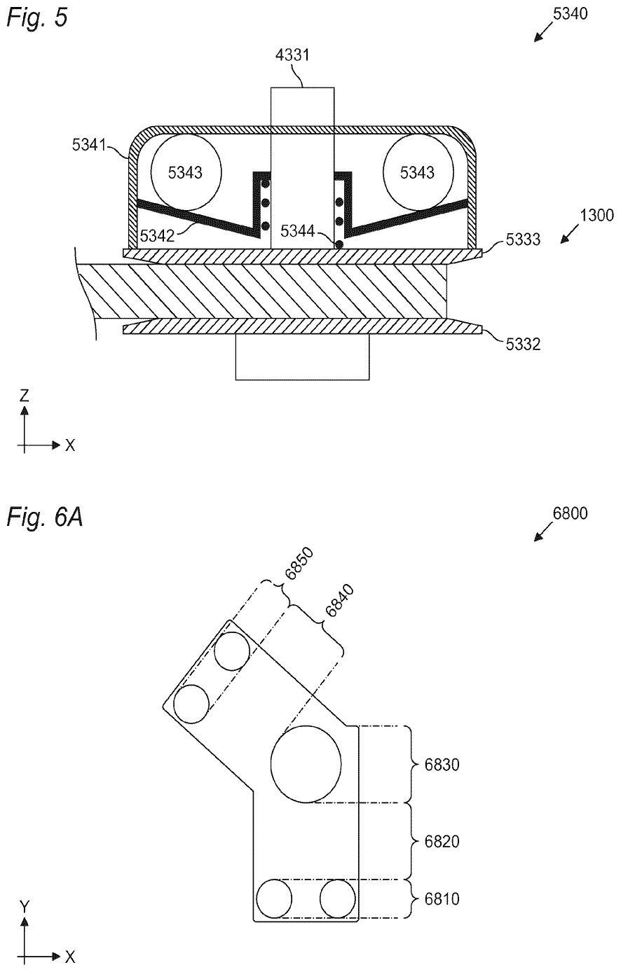

As visible in FIG. 2, the second input gear 2220 and the third input gear 2230 can be mounted on the same axle 2250, which can be mounted on two bearings 2260, 2261. As visible, a longitudinal axis of the axle can be positioned in a region between the input pulley 1310 and the output pulley 1330. Alternatively, or in addition, the longitudinal axis of the axle can be positioned so as not to cross a case of the centrifugal actuator of the output pulley, for instance case 5341 visible in FIG. 5 and not num-bered in FIG. 2.

This positioning of the axle 2250 is particularly advantageous, because it results in use of space in a location of the gearbox 1000 where there would otherwise be unused space. As will become clearer from the description of further preferred embodiments, this is further advantageous since the space around the axle 2250 can be used for mounting sensors, as well as the respective electronics and/or cables.

FIG. 3 schematically illustrates a partial top view of a bicycle gearbox 3000, with a top housing portion removed and with a cut view of a pulley sheave 3312, taken along line B-B′ of FIG. 1A, comprising a possible embodiment of a freewheel 3700.

In particular, as visible in FIG. 3, bicycle gearbox 3000 can further comprise a freewheel 3700, which is generally mounted on the input pulley 1310, so as to operate between the input pulley 1310 and the respective axis 3314. The freewheel, in this case, can have the same function and thus substitute the freewheel generally placed in the rear wheel hub of a bicycle.

In the specific implementation illustrated, the input pulley 1310 is configured to rotate with an input pulley axis 3314, and comprises two pulley sheaves 3312 and 3313. In the embodiment as illustrated, pulley sheave 3312 is fixed with respect to the axis 3314, while pulley sheave 3313 can slide along axis 3314, and is kept in position by the input pulley spring 1311 and by the action of the V-belt on the sheaves 3312, 3313. Preferably, as illustrated, the freewheel 3700 is connected, or mounted, between the input pulley axis 3314 and the fixed sheave 3312.

In this preferred configuration, the freewheel 3700 is connected, or mounted, between the input pulley axis 3314 and the input pulley 1310 so that when the torque applied by the input pulley axis 3314 to the input pulley 1310 is in one direction, the torque is transferred, when it is applied in the opposite direction no torque is transferred.

The placement of the freewheel 3700 between input pulley axis 3314 and input pulley 1310 is particularly advantageous because the torque applied to the freewheel is reduced, due to the action of the input gears 1200. Since less torque has to be transferred, the freewheel can be made smaller and thus lighter, as well as cheaper. Moreover, also due to the multiplication action of the input gears 1200, the play in the crankshaft, due to the respective play at the freewheel 3700, can be significantly reduced compared to the prior art, so that the user has less play in the pedals when pedaling.

Moreover, as visible in FIG. 3, the freewheel 3700 can be substantially coplanar with the sheave to which it is connected, for instance fixed sheave 3312. In this manner, the dimensions along the Z direction of the gearbox are kept low.

In the embodiments described so far, the housing 1100 has been generally described as encasing the gearbox 1000. As it will be appreciated by those skilled in the art, this can be implemented in several ways, for instance housing components can be manufactured separately and then assembled together in a variety of ways.

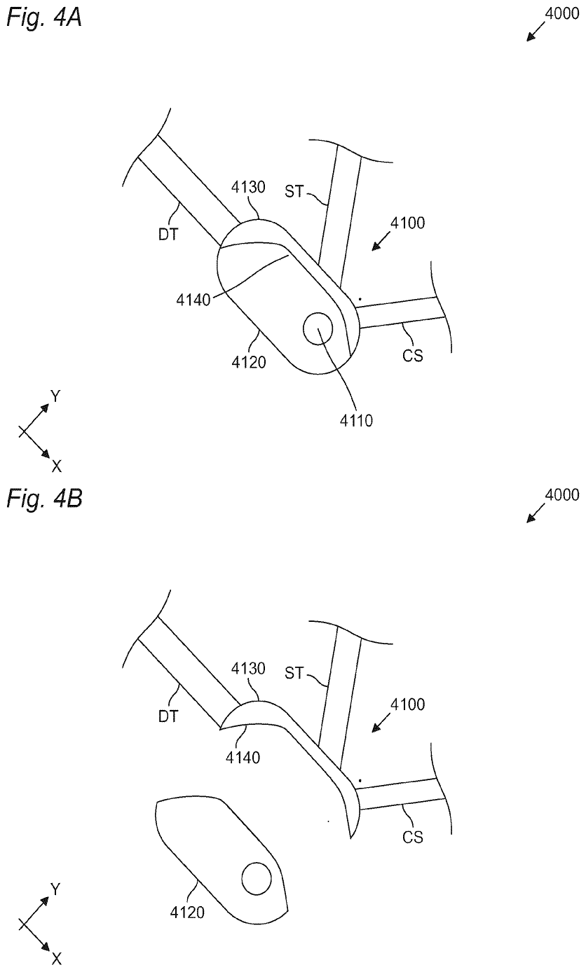

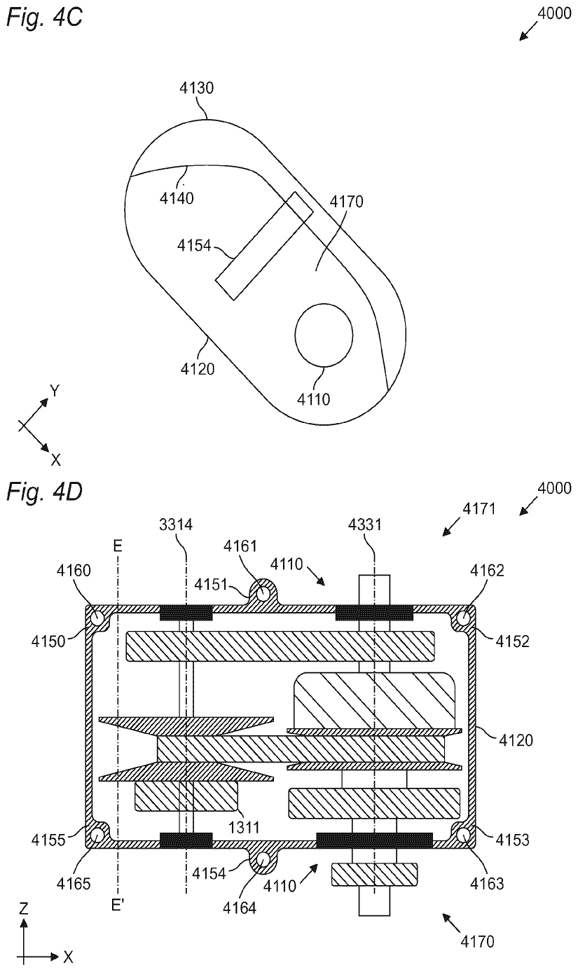

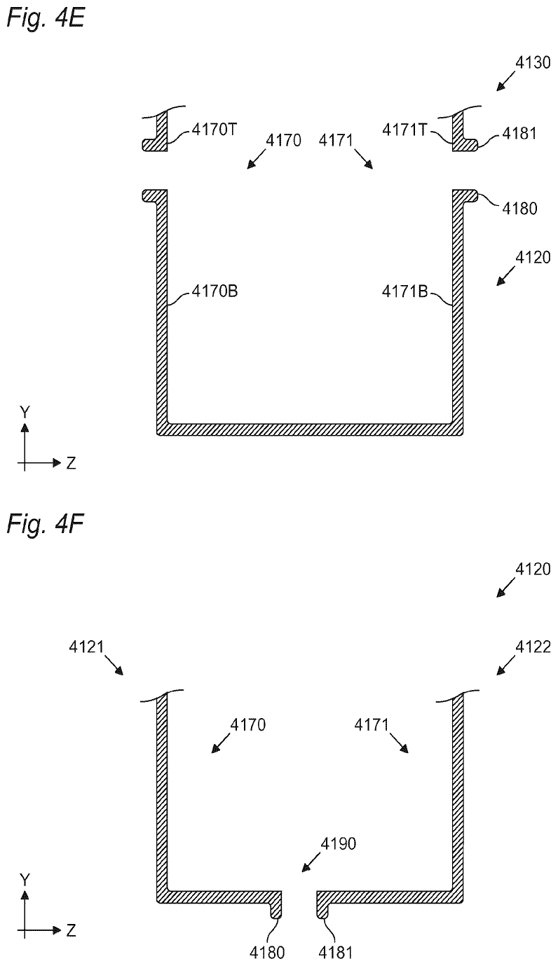

FIGS. 4A-4F schematically illustrate a specific possible implementation of a housing 4100.

In particular, FIG. 4A schematically illustrates an enlarged view of bicycle gearbox 4000 in a closed state. The same gearbox 4000 is shown in FIG. 4B in an open state. FIG. 4C schematically illustrates an enlarged view of the bicycle gearbox 4000 in a closed state, comprising an optional rib 4154. FIG. 4D schematically illustrates a top view of bicycle gearbox 4000 in an open state and with a top housing portion removed.

FIGS. 4E and 4F schematically illustrate optional implementations of a section of housing 4100, in an open position, taken along line E-E′ of FIG. 4D.

As visible in FIGS. 4A and 4B, the housing 4100 is split along a first split line 4140 into a bottom housing portion 4120 and a top housing portion 4130, so that the bottom housing portion 4120 and the top housing portion 4130 are connected to each other in a separable manner.

In preferred embodiments, the bottom housing portion 4120 is larger than the top housing portion 4130. Preferably, the bottom housing portion 4120 is configured to contain the majority of, preferably all of, the components of the gearbox 4000, and the top housing portion 4130 can act as a lid to close the bottom housing portion 4120.

This configuration is particularly advantageous in that the separation in bottom and top housing allows the top housing portion 4130 to be structurally connected to the frame of the bicycle, while the bottom housing portion 4120 can be opened for assembling and/or maintaining the gearbox components. In particular, by removing the top housing portion 4130, the bottom housing portion 4120 can be made open on its upper part, which can enable easy access to the transmission component. This is in contrast to some existing solution, in which removal of a top housing portion, for instance in form of a bracket, still provides no access to the components inside of the housing.

This advantageously enables an easy maintenance of the components inside of the housing by simply disconnecting the top housing portion 4130 from the bottom housing portion 4120.

Additionally, in preferred embodiments, a majority of the components, in some even preferred embodiments all of the components, contained within the housing 4100 can be kept in place by, and/or are structurally connected to, the bottom housing portion 4120.

In this manner, the top housing portion 4130 can be shipped to frame manufacturers for connection to the frame, while the bottom housing portion 4120 can be shipped, with the components of the gearbox mounted within it, to bicycle manufacturers. The bicycle manufacturers can then receive the frame with the top housing portion 4130 mounted thereon, thus enabling an easy mounting of the previously assembled gearbox, by simply connecting the top housing portion 4130 to the bottom housing portion 4120.

Moreover, this approach allows the top housing portion 4130 to have specifically designed forms and/or brackets, for connection to the frame, while maintaining a limited number of designs, preferably a single design, for the bottom housing portion 4120. In this manner the gearbox can be adapted to a plurality of frames while keeping a single design for most of the components of the gearbox, preferably for all components of the gearbox except for the top housing portion 4130.

Preferably, the housing 4100 comprises two side surfaces 4170, 4171 substantially perpendicular the crankshaft 1600. The side surfaces are preferably substantially parallel to each other and are preferably extending substantially along the elongation axis EA. The split line is configured to go split the housing 4100 across side surfaces 4170, 4171, resulting in bottom side surface portions 4170B, 4171B and top side surface portions 4170T, 4171T.

By splitting the housing in this manner, the top housing portion 4130 contains no further split line and can thus be used for a reliable connection to the bike frame, preferably by welding. In preferred embodiments as illustrated in the figures the top housing portion 4130 can thus be configured for being solidly connected to a seat tube ST and to a down tube DT of a bicycle frame BF, or any other non-standard bicycle frame configuration.

Thanks to this implementation it is advantageously possible to allow the upper housing portion 4130 to be welded in the frame assembly. The lower housing portion 4120 containing the transmission components can then be easily assembled to the upper housing portion 4130, for instance through screws or other connecting means.

Preferably, in some embodiments, the top housing portion 4130 is configured for being further solidly connected to chain stays CS of the bicycle frame BF.

By connecting the top housing portion to more than one frame tube, the housing 4100 also can act as structural element of the frame, reducing the frame's total weight.

As can be seen in FIG. 4C, the split line 4140 is configured such that the crankshaft openings 4110 are realized in the bottom housing portion 4120. In other words, the crankshaft openings 4110 are realized in the bottom side surface portions 4170B, 4171B. This allows a precise assembling of the crankshaft and bearings, and generally all transmission parts, as the machining and assembling can be done without involvement of the top housing portion 4130. The bottom housing portion can then be pre-assembled and shipped to bicycle manufacturers for connection to the frame.

Further preferably, in some embodiments, the input pulley 1310 can be configured to rotate on an input pulley axis 3314, and the output pulley 1330 can configured to rotate on an output pulley axis 4331. An extension of the input pulley axis 3314 and an extension of the output pulley axis 4331 both cross a side surface 4170, 4171 of the bottom housing portion 4120, namely bottom side surface portions 4170B, 4171B.

As for the crankshaft opening, this allows easy assembling of the various components, such as the bearings for the input pulley axis 3314 and the output pulley axis 4331, and easy production.

In some embodiments, as visible for instance in FIGS. 4C and 4D, the housing 4100 can comprise a plurality of ribs 4150-4155 with a corresponding plurality of holes 4160-4165, wherein at least a first one 4151, 4154 of the ribs 4150-4155 is integrated in a respective one of the side surfaces 4170, 4171.

As it will be clear to those skilled in the art, the plurality of ribs 4150-4155 can be implemented by a thickening of the material in the respective side surface 4170, 4171. Preferably the ribs 4150-4155 have an elongated shape, and the holes 4160-4165, can be implemented to have a longitudinal extension substantially parallel to that of the ribs. The ribs are preferably implemented on the outside of the housing, so that the holes can be accessible for inserting respective screws, as connecting means for connecting the top and bottom housing portions.

Preferably one or more of the ribs 4151-4155 is substantially perpendicular to the first split line 4140. In this manner, in addition to serving as thickening of the housing for the realization of the holes, the ribs can result in an increased strength of the housing, which avoids flexing of housing casing under load, keeps bearings and axles aligned, and avoids wear and noise of the gearbox.

As previously described, the input pulley 1310 is configured to rotate on an input pulley axis 3314 and the output pulley 1330 is configured to rotate on an output pulley axis 4331. With respect to those references, at least one of the ribs 4150-4155 is positioned between the input pulley axis 3314 and the output pulley axis 4331. This position, which thus results approximately in the middle of the surface 4170, 4171, along the elongation axis EA, is particularly advantageous since it provides strength at a position which is most likely to flex under load.

As it will be clear to those skilled in the art, the interface at the bottom housing portion and the top housing portion can be implemented in various manners. However, as visible in FIGS. 4E and 4F, in particularly advantageous embodiments, at least one of the bottom housing portion 4120 and the top housing portion 4130 can comprise a flange 4180, 4181 along the first split line 4140.

This implementation is particularly advantageous because it helps in reducing flexing of housing under load, thus avoiding wear and noise. Moreover, the flange is an ideal surface for the placement of a gasket, ensuring that the interior of the housing is closed to the environment.

While in the embodiments described above the housing is provided with only one split line, the invention is not limited to this implementation. In particular, as visible in FIG. 4F, the bottom housing portion 4120 can be further split along a second split line 4190 into a first bottom housing portion 4121 and a second bottom housing portion 4122. The second split line 4190 can be interpolated by a plane which is substantially perpendicular to a plane interpolating the first split line 4140. In other words, the second split line can extend along the elongation axis EA of the housing, however along a bottom surface which is substantially perpendicular to the side surfaces 4170, 4171.

The second split line 4190 simplifies the assembling of the gearbox components within the bottom housing portion 4120, in that the components can be positioned in one among the first or second bottom housing portion, and then the first and second bottom housing portions can be brought together. As will be clear to those skilled in the art, the first and second bottom housing portions can be secured together in a variety of manners, for instance through ribs similar to ribs previously described for the first split line 4140. Moreover, as visible in FIG. 4F, a flange 4180, 4181 can also be implemented along the second split line 4190.za

In the embodiments described above, the operation of the continuously variable transmission has only been summarily described, particularly in relation to how the output pulley 1330 is controlled.

A commonly known method for controlling the opening of the output pulley is to use a centrifugal actuator. FIG. 5 schematically illustrates a cut view of a possible embodiment of such centrifugal actuator, in the form of centrifugal actuator 5340.

In particular, as visible in FIG. 5, the output pulley 1330 can comprise a sliding sheave 5333 and a fixed sheave 5332, as well as a centrifugal actuator 5340 configured to control the output pulley 1330 as a function of the rotational speed of the output pulley 1330. In particular, the centrifugal actuator 5340 can be generally configured to control the sliding sheave 5333 so as to move the sliding sheave 5333 away from the fixed sheave 5332 as the rotational speed of the output pulley 1330 decreases, and, conversely, to move the sliding sheave 5333 towards the fixed sheave 5332 as the rotational speed of the output pulley 1330 decreases.

As visible in FIG. 5, the centrifugal actuator 5340 comprises a case 5341, a plate 5342, and a plurality of weights 5443 placed between the case 5341 and the plate 5342, such that the weights are configured to push the case 5341 away from the plate 5342 as the output pulley 1330 rotates. The centrifugal actuator 5340 further comprises a spring 5344 configured to bias the sliding sheave 5333 towards the fixed sheave 5332, to clamp the belt. The spring can do so by being compressed between the plate 5342 and the sliding sheave 5333, on a side of the sliding sheave 5333 opposite to the fixed sheave 5332. The plate 5342 can be advantageously configured so that a free volume is present, radially, between the plate 5342 and the output pulley axis 4331 such that the spring 5344 can be positioned in the free volume.

It will be understood that this can be implemented in a number of ways and that the illustrated embodiment is only one possible specific implementation.

In general, the plate can have a sloping surface, over which the weights 5433 can slide or roll. This sliding surface can be connected to an axis-facing surface, which is substantially parallel to the axis 4331 such that space is left between this surface and the axis 4331. The plate can also have a connecting surface, connecting the axis-facing surface with the axis 4331. Preferably, the connecting surface is substantially perpendicular to the axis-facing surface and/or to the axis 4331. Even more preferably, the connecting surface can be connected to an end of the axis-facing surface, while another end of the axis-facing surface can be connected to the sloping surface.

Independently of the specific implementation, the centrifugal actuator can thus be configured so that the spring 5433 is positioned substantially at the same region, along the direction of axis 4331, of the sloping surface, and/or of the weights 5343. This is in contrast to the solution known in the prior art, where the spring is usually placed below the region of the sloping surface, in the direction Z of the figures, causing a larger width of the housing, in the Z direction.

The gearbox of the invention is particularly well suited for electric bike applications. This is because the amount of torque that can be handled by the continuously variable transmission 1300 can be particularly high, owing to the reduction in torque applied to it thanks to the increase in rotational speed.

Electric bikes generally require the presence of a sensor indicating the force being applied by the cyclist on the pedals, so that the electric motor can be controlled accordingly. Such sensors are known, in the prior art, to be placed in the pedals and/or in the crank. However both those placements present various issues.

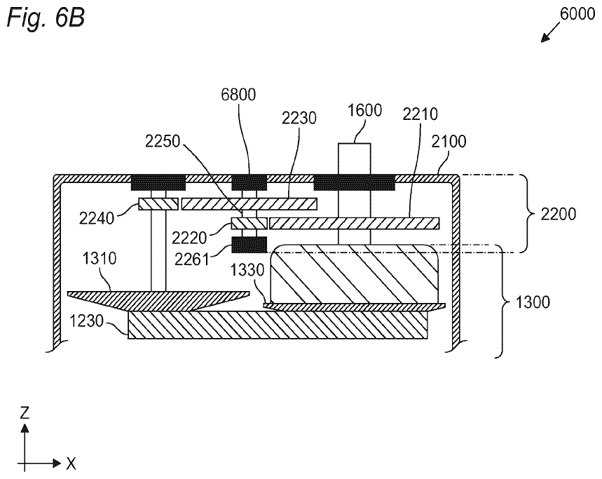

Those issues can be solved, as will become clearer from the following description, by placing a force sensor within the gearbox. FIG. 6A schematically illustrates a force sensor 6800, FIG. 6B schematically illustrates a possible mounting location of force sensor 6800 inside of a bicycle gearbox 6000.

In particular, as visible in FIG. 6A, a force sensor 6800 can comprise a first connecting portion 6810, configured to enable a connection of the force sensor to the housing. The connection can be performed in known manners, for instance through connecting means such as screws, etc.

The force sensor 6800 can further comprise a holding portion 6830 configured to hold any of the axles of the continuously variable transmission 1300, input gears 1200, 2200, and output gears 1400. The holding can be made in any manner per se known, by providing a mounting point in the holding portion 6830 for the part to be held. For instance, the holding portion 6830 can be configured to enable a bearing to be supported, the bearing holding the given axis in place.

The force sensor 6800 can further comprise a first strain gauge 6820 configured to measure a strain between the first connecting portion 6810 and the holding portion 6830.

Thanks to this implementation, under load, a given torque will be applied to any of the axis of the gearbox, and can be measured by the strain gauge. However, in contrast with the prior art, since the strain gauge can measure load on the transmission in the gearbox independently on which pedal is generating the force, the sensor, and therefore the electric bicycle, can apply power assistance based on the load directly from each pedal stroke the rider makes, providing an improved rider experience. In addition, this strain gauge design is cheaper to develop, produce and control, and it is less sensitive to tolerances than other sensors styles, such as electro-magnetic torque sensors or externally mounted sensors, which need protective elements and are susceptible to damage.

In the embodiment illustrated in FIG. 6A, the force sensor further comprises a second connecting portion 6850, connected to the housing and a second strain gauge 6840 configured to measure a strain between the second connecting portion 6850 and the holding portion 6830. The same considerations made for the respective first elements apply to the corresponding second elements.

This implementation is particularly advantageous as it allows to compensate for temperature variations. In particular, the two strain gauges can be mounted in opposite directions with respect to the holding portion, so that any material expansion differences between the sensor and the bracket are cancelled out.

It is remarked that while the force sensor in FIG. 6A has an angle between a first direction, connecting the first connecting portion 6810 and the holding portion 6830, and a second direction, connecting the second connecting portion 6850 and the holding portion 6830, the present invention is not limited thereto. In principle the sensor can have any shape.

It has however been found that the angle between the first and second direction best counters the force applied on the holding portion 6830 and provides a more stable holding characteristic, resulting in less noise and wear. In preferred embodiments, the angle between the first and second direction is preferably comprised between 30 and 60 degrees.

In preferred embodiments, the holding portion 6830 is preferably configured to hold an axle of the input gears 1200, 2200 rotating faster than the crankshaft 1600. As this axis rotates faster than the pedal crank, a higher resolution data output is achieved with the same quality of sensor compared to the pedal crank.

For instance, FIG. 6B schematically illustrates a possible mounting position of the force sensor. In this specific implementation, the force sensor is configured to hold one end of the axis 2250, through a corresponding bearing mounted within the force sensor.

Preferably, any rotating axis inside the gearbox can be used for sensing through the sensor. However, in further preferred embodiments, the sensor is preferably mounted on axis which are positioned before the freewheel, in the direction of transfer of the torque from the pedals to the wheel, so as to ensure constant monitoring of the pedal, and avoiding feeling back pressure from the rear wheel rotating the CVT.

While various embodiments above have been directed to a gearbox, it will be clear that the invention can also be implemented as a bicycle frame, BF in the figures, comprising a seat tube ST, a down tube DT and chain stays CS, and any of the bicycle gearbox described above.

Preferably, the gearbox is solidly connected to at least the seat tube ST and to the down tube DT. This is considered to be particularly advantageous since it is an ideal positioning for the crankcase, and allows the gearbox to become an integral part of the frame so that weight for bottom bracket of frame can be avoided.

In preferred embodiments, where the housing is split into a top and bottom housing portion, the top housing portion 4130 is preferably solidly connected to at least the seat tube ST and to the down tube DT, while the bottom housing portion 4120 is preferably not solidly connected to the bicycle frame BF.

Embodiments of the invention can also relate to a bicycle comprising any of the bicycle gearboxes or the bicycle frame BF described above.

### LIST OF REFERENCE NUMERALS

1000: bicycle gearbox
1100: housing
1110: crankshaft opening
1200: input gears
1300: continuously variable transmission
1310: input pulley
1311: input pulley spring
1320: V-belt
1330: output pulley
1340: centrifugal actuator
1400: output gears
1500: chain sprocket
1600: crankshaft
BF: bicycle frame
DT: down tube
HT: head tube
ST: seat tube
TT: top tube
SS: seat stays
CS: chain stays
EA: elongation axis
2000: bicycle gearbox
2200: input gears
2210-2240: gear
2250: axle
2260-2261: bearing
3000: bicycle gearbox
3312: fixed sheave
3313: sliding sheave
3314: input pulley axis
3700: freewheel
4000: bicycle gearbox
4100: housing
4110: crankshaft opening
4120: bottom housing portion
4121: first bottom housing portion
4122: second bottom housing portion
41230, 4124: flange
4130: top housing portion
4140: first split line
4150-4155: ribs
4160-4165: holes
4170, 4171: side surface
4170B, 4171B: bottom side surface portion
4170T, 4171T: top side surface portion
4180, 4181: flange
4190: split line
4331: output pulley axis
5332: fixed sheave
5333: sliding sheave
5340: centrifugal actuator
5341: case
5342: plate
5443: weight
5344: spring
6000: bicycle gearbox
6800: force sensor
6810: connecting portion
6820: strain gauge
6830: holding portion
6840: strain gauge
6850: connecting portion

1. A bicycle gearbox comprising
a housing, the housing comprising two crankshaft openings, configured to allow a crankshaft to pass through the housing,
a continuously variable transmission comprising an input pulley, an output pulley and a V-belt connecting the input pulley and the output pulley,
a chain sprocket, configured to connect to a chain connecting to the rear wheel,
input gears configured to connect the crankshaft to the input pulley, the input gears being configured to increase a rotational speed of the crankshaft and provide the increased rotational speed to the input pulley,
output gears configured to connect the output pulley to the chain sprocket, the output gears being configured to reduce a rotational speed of the output pulley and provide the reduced rotational speed to the chain sprocket,
wherein the output pulley is coaxial with the crankshaft.

2. The bicycle gearbox according to claim 1, wherein
the input gears are configured to increase the rotational speed of the input pulley with respect to the rotational speed of the crankshaft by an increasing factor,
wherein the increasing factor is at east one of at least 10, at least 20, or at least 25, and/or
wherein the increasing factor is at least one of less than 50, less than 40, or less than 35.

3. The bicycle gearbox according to claim 1, wherein
the output gears, are configured to reduce the rotational speed of the output pulley by a reducing factor,
wherein the reducing factor is at least one of at least 0.01, at least 0.05, or at least 0.1, and/or
wherein the reducing factor is at least one of less than 0.3, less than 0.2, or less than 0.15.

4. The bicycle gearbox according to claim 1, wherein
the continuously variable transmission is configured to have a gear range between at least one of 1.5 and 10 or between 1.8 and 4.

5. The bicycle gearbox according to claim 1, wherein
the input gears and the continuously variable transmission are configured so that the input pulley, when the gearbox is in use, has an input rotational speed,
wherein the input rotational speed is at least one of at least 500 RPM, at least 1000 RPM, or at least 1500 RPM, and/or
wherein the input rotational speed is at least one of less than 3500 RPM, less than 3000 RPM, or less than 2500 RPM.

6. The bicycle gearbox according to claim 1, wherein
the output gears and the continuously variable transmission are configured so that the output pulley, when the gearbox is in use, has an output rotational speed,
wherein the output rotational speed is at least one of at least 500 RPM or at least 700 RPM, and/or
wherein the output rotational speed is at least one of less than 4500 RPM or less than 4000 RPM. and/or
wherein the output rotational speed has a range of at least one of at least 1000 RPM, at least 2000 RPM, or at least 2500 RPM.

7. The bicycle gearbox according to claim 1, wherein
the housing has its longest dimension along a main elongation axis and is configured to be connected to a frame tube of a bicycle,
wherein the frame tube can be any of a seat tube, a down tube and chain stays, or other non-standard frame construction,
and wherein the housing is configured to be connected to the frame tube such that the frame tube is positioned parallel to the main elongation axis.

8. The bicycle gearbox according to claim 1, wherein
the output gears are an epicyclic gear system, comprising a sun gear, a plurality of planet gears and a ring gear, and
the sun gear is coaxial with the crankshaft.

9. The bicycle gearbox according to claim 1, wherein
the chain sprocket is coaxial with the crankshaft.

10. The bicycle gearbox according to claim 1, wherein
the input gears are a parallel spur gear system.

11. The bicycle gearbox according to claim 1, wherein
the input gears comprise a first input gear, a second input gear actuated by the first input gear, a third input gear connected to the second input gear, and a fourth input gear actuated by the third input gear,
the second input gear and the third input gear are mounted on an axle, and
a longitudinal axis of the axle is positioned in a region between the input pulley and the output pulley.

12. The bicycle gearbox according to claim 1, further comprising a freewheel,
wherein the input pulley is configured to rotate with an input pulley axis, and
wherein the freewheel is connected between the input pulley axis and the input pulley.

13. The bicycle gearbox according to claim 12,
wherein the input pulley comprises a fixed sheave and a sliding sheave,
wherein the freewheel is at least one of connected between the input pulley axis and the fixed sheave or substantially coplanar with the fixed sheave.

14. (canceled)

15. The bicycle gearbox according to claim 1, wherein
the housing is split along a first split line into a bottom housing portion and a top housing portion, and
the bottom housing portion and the top housing portion are connected to each other in a separable manner.

16. The bicycle gearbox according to claim 15, wherein
the top housing portion is at least one of configured for being solidly connected to a seat tube and to a down tube of a bicycle frame, or any other non-standard bicycle frame configuration, or is configured for being solidly connected to chain stays of the bicycle frame.

17. (canceled)

18. (canceled)

19. (canceled)

20. The bicycle gearbox according to claim 15, wherein
the housing further comprises a plurality of ribs with a corresponding plurality of holes,
the housing further comprises two side surfaces substantially perpendicular the crankshaft,
wherein at least a first one of the ribs is integrated in a respective one of the side surfaces.

21. (canceled)

22. The bicycle gearbox according to claim 15, wherein
at least one of the bottom housing portion and the top housing portion comprises a flange along the first split line, or
the bottom housing portion is split along a second split line into a first bottom housing portion and a second bottom housing portion.

23. (canceled)

24. The bicycle gearbox according to claim 1,
wherein the output pulley comprises a sliding sheave and a fixed sheave, the gearbox further comprising a centrifugal actuator configured to control the output pulley as a function of the rotational speed of the output pulley, the centrifugal actuator comprising
a case,
a plate,
a plurality of weights placed between the case and the plate, such that the weights are configured to push the case away from the plate as the output pulley rotates,
a spring configured to bias the sliding sheave towards the fixed sheave to clamp the belt,
and wherein the plate is configured so that a free volume is present radially between the plate and the output pulley axis such that the spring can be positioned in the free volume.

25. The bicycle gearbox according to claim 1, further comprising a force sensor locating inside the housing, the force sensor comprising
a first connecting portion connected to the housing,
a holding portion configured to hold one axle of any of the continuously variable transmission, input gears, and output gears, and
a first strain gauge configured to measure a strain between the first connecting portion and the holding portion.

26. The bicycle gearbox according to claim 25, wherein
the force sensor further comprises a second connecting portion connected to the housing and a second strain gauge configured to measure a strain between the second connecting portion and the holding portion.

27. (canceled)

28. A bicycle frame comprising
a seat tube, a down tube and chain stays, and
the bicycle gearbox according to claim 1,
wherein the bicycle gearbox is solidly connected to at least the seat tube and to the down tube.

29. The bicycle frame according to claim 28, wherein
the top housing portion is solidly connected to at least the seat tube and to the down tube,
the bottom housing portion is not solidly connected to the bicycle frame.

30. (canceled)

31. The bicycle gearbox according to claim 15, wherein the first one of the ribs is substantially perpendicular to the first split line.
